(19) United States
(12) Patent Application Publication
(10) Pub. No.: US 2006/0283957 A1
(43) Pub. Date: Dec. 21, 2006

(54) Scented authorization card

(75) Inventors: James Blumenfeld, Lincroft, NJ (US); Adam Bell, Short Hills, NJ (US)

Correspondence Address: DARBY & DARBY P.C., P. O. BOX 5257, NEW YORK, NY, 10150-5257, US

(73) Assignee: Rotuba Extruders, Inc., Linden, NJ (US)

(21) Appl. No.: 11/440,251

(22) Filed: May 23, 2006

Related U.S. Application Data
(60) Provisional application No. 60/692,644, filed on Jun. 20, 2005.
(60) Provisional application No. 60/705,807, filed on Aug. 4, 2005.
(60) Provisional application No. 60/739,304, filed on Nov. 23, 2005.

(51) Int. Cl. G06K 19/00; G06K 19/06

(52) U.S. Cl. 235/487; 235/493

(57) ABSTRACT

An authorization card that has two broad surfaces and an edge therebetween. The machine-readable code supported on the card contains data that is readable by an electronic device. A fragrance is substituted for a portion of a plasticizer within the plastic body and diffuses into the ambient over a long period of time.

This application claims the benefit under 35 U.S.C. §119(e) of U.S. Provisional Application Nos. 60/739,304, filed Nov. 23, 2005, 60/705,807, filed Aug. 4, 2005 and 60/692,644, filed Jun. 20, 2005, each of which is hereby incorporated by reference in its entirety.

### FIELD OF THE INVENTION

The present invention relates to scented authorization cards, and more specifically, relates to plastic authorization cards with a fragrance embedded in the plastic.

### BACKGROUND OF THE INVENTION

Authorization cards are ubiquitous in modern society; the average person carries several and uses authorization cards many times every day.

Authorization cards, as that term is used herein, include any card that communicates information with an electronic device. Typical authorization cards include credit cards, debit cards, gift cards, smart cards, digital access keys, identification cards and consumer club cards, amongst others. Such cards are read using an electronic device in order to transmit information related to the card itself or to an account or record associated with the owner or holder of the card. The electronic device reads a machine-readable code supported by the card. Examples of machine readable codes include magnetic stripes, bar codes and devices that receive or transmit electromagnetic signals (e.g., RFID tags).

Because of the abundance of authorization cards that are available, there is a desire by both the card owners and suppliers to make the cards unique. Known methods of personalizing or differentiating authorization cards are by printing graphics on the card's outer layer, adding holographic images, pictures and the like.

Authorization cards also frequently include important information, such as the account number, embossed in the card. This ensures that this information cannot be accidentally removed and permits a mechanical transfer of the card number to a carbon-backed receipt.

Methods of manufacturing authorization cards with the foregoing features are old and well known. An exemplary method of producing an authorization card is disclosed in U.S. Pat. No. 6,644,551 to Clayman et al., which is hereby incorporated by reference. The conventional method of producing an authorization card is by laminating one or more layers to each side of a polyvinyl chloride acetate or polyvinyl chloride (PVCA or PVC) core followed by adding a magnetic stripe, graphics, stickers, embossing, printing and the like. Other substrates and lamination layers include, but are not limited to paper, polyester, etc. Some of these are described in U.S. Pat. Nos. 6,769,718, 6,305,716, 6,039,356, 6,030,701, 5,863,076, 5,769,457, 5,495,981, and 4,978,146.

The art is improved by providing further differentiations from known credit card constructions. The present invention addresses that need.

### SUMMARY OF THE INVENTION

The present invention is advantageous over the prior art because it provides an authorization card with an additional unique feature to those known in the art. As an improvement in the art, a scented substrate having a fragrance substituted for a portion of the plasticizer in the conventional card core, and has material characteristics enabling the construction of an authorization card having a thin plastic body which supports a machine-readable code thereon. The authorization card has two broad surfaces and an edge therebetween. The machine-readable code contains data that is readable by an electronic device. The fragrance embedded within the plastic body is perceptible to a user and adds uniqueness to the card. The embedded fragrance lasts a considerable length of time.

Alternatively, the core of the card is made of a cellulosic material instead of a conventional core (polyvinyl chloride or polyvinyl chloride acetate) and fragrance is substituted for a portion of the plasticizer. A card with a cellulosic core can offer the consumer a card with a translucent appearance (the card can have a monolithic strucutre) and provides a better carrier for the fragrance.

There and other aspects, features and advantages of the present invention will be appreciated from the following written description and accompanying drawing figures.

### BRIEF DESCRIPTION OF THE DRAWINGS

FIG. 1. is a front view of an authorization card in accordance with the invention;

FIG. 2 is a side view of the authorization card of FIG. 1; and

FIG. 3 is a back view of the authorization card of FIG. 1.

### DETAILED DESCRIPTION OF THE PREFERRED EMBODIMENT

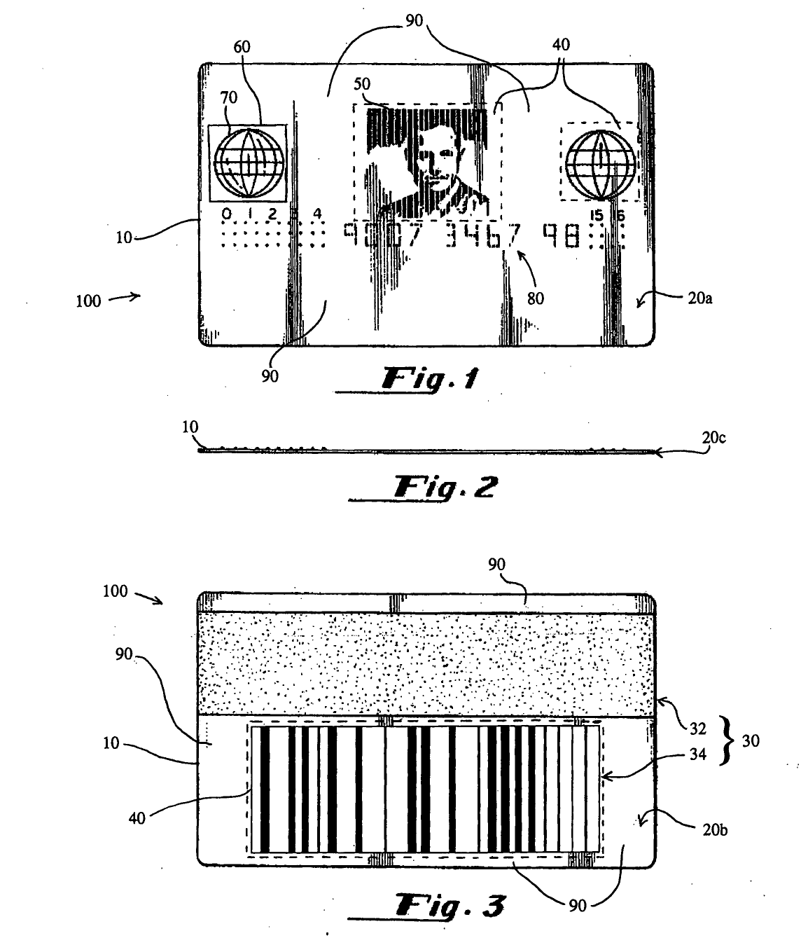

An exemplary embodiment of the authorization card 100 of the claimed invention is shown in FIGS. 1-3. The card 100 includes a thin plastic body 10 having a first broad surface 20a and a second broad surface 20b with a thin edge 20c therebetween. The card is preferably rectangular with rounded corners. However, any two dimensional shape could be used as an authorization card so long as it satisfies industry standards for machine-readability. The thin plastic body 10 is preferably a monolithic substrate which differs from conventional PVC and PVCA cards in having a cellulosic substrate with a fragrance substituted for a portion of the plasticizer such that the fragrance is embedded therein. More preferably, the plastic body comprises a fragrance-embedded cellulose acetate propionate. The term “cellulosic” refers to cellulose acetates and cellulose acetate esters and includes, but is not limited to, cellulose acetate, cellulose acetate propionate, and cellulose acetate butyrate. Cellulose acetate esters include, but are not limited to, cellulose diacetate and cellulose triacetates. The term “cellulosic” also includes all hydrates of cellulosics (e.g. anhydrous cellulose acetate, cellulose acetate monohydrate, cellulose acetate dihydrate, cellulose acetate trihydrate, and cellulose acetate tetrahydrate) as well as anhydrous forms of cellulosics. Techniques for introducing fragrance into cellulosics are described in co-pending U.S. Application Ser. Nos. 60/739,304, filed Nov. 23, 2005, 60/705,807, filed Aug. 4, 2005 and 60/692,644, filed Jun. 20, 2005, the entireties of each said application being hereby incorporated by reference.

Authorization card 100 includes one or more machine readable codes 30, such as magnetic stripe 32 or bar code 34. The machine readable code 30 contains data which an electronic device reads. The data identifies authorization card 100 to the electronic device. Unlike PVC and PVCA cores used for conventional authorization cards, the plastic body 10 of the authorization card 100 can have considerable translucency up to complete transparency when constructed of a cellulosic, and can include a dye or the like to provide the plastic body 10 with a color, if desired.

The authorization card 100 has printed indicia disposed on a portion of its broad surfaces 20a, 20b. The card 100 optionally has a primer 40 to enable an image 50 and any other printing to print clearly and not wear off easily. There are many different printing methods that can be used. The preferred method is digital printing without the use of a primer layer. Such printing technique prints in a dithered pattern of ink dots to impart images and characters to the broad surface of the card while simultaneously preserving unprinted real estate on the card surface for fragrance emission. There remain large amounts of unprinted areas between the dots that allow for fragrance migration into the ambient. Barcodes, when provided, can be printed onto the cards, and need not be provided on a laminate. A laminate section 60 can be joined to the first broad surface 20a by glue or heat lamination to provide, for example, a hologram, magnetic stripe or smart card/RFID feature to the card 100. Thus, the machine-readable code 30 can be disposed in the laminate section 60, in certain constructions that are in accordance with the present invention. An embossed portion 80 also can be provided in the plastic card 10.

The illustrated embodiment is free of any laminate or covering layer on broad surfaces 20a, 20b. Consequently, the optical properties of the core of the plastic card 10 are visible to the user and not sandwiched in a laminate structure. In a preferred embodiment, the core of the card is a translucent cellulosic material and does not contain (that is, the card is free of any) polyvinyl chloride or polyvinyl chloride acetate or polyester. Further, regions 90 are exposed to the environment to permit unimpeded diffusion of the fragrance from the plastic body 10 into the ambient. Thus the regions 90 freely breath and thereby impart the fragrance to the environment. To further promote permeation of the fragrance into the air, one or more of the exposed regions 90 can have a matted finish (not shown for clarity of the drawings) which increases the surface area of the exposed regions 90, thereby increasing the communication between the plastic body 10 and the ambient.

In a preferred construction, the regions 90 on the first and second broad surfaces 20a, 20b are arranged to be distributed about the plane of the card 10 so that evaporation of fragrance is even across the card surface. This arrangement minimizes any warping that might occur in a coreless construction after some of the (non-laminated) fragrance has evaporated.

Alternatively, the authorization card 100 can include a laminate on a substantial portion of one or more surfaces of the thin plastic body 10. The laminate can impart dimensional stability to the card, but is preferably arranged to not substantially impede permeation of the fragrance into the ambient. Alternatively, there may be a full surface lamination on either side 20a or 20b, but in this configuration the fragrance will only emit from the opposite surface and the edges 20c.

Although the preferred form of the invention has been shown and described, many features may be varied, as will readily be apparent to those skilled in this art. It is the intention, therefore, to be limited only as indicated by the scope of the claims appended hereto.

We claim:

1. An authorization card comprising:
a thin plastic body having:
a first broad surface,
a second broad surface opposite the first broad surface, and
an edge therebetween,
a fragrance contained within the thin plastic body; and
a machine readable code supported on the thin plastic body.

2. The authorization card of claim 1 wherein the plastic body of the card comprises a monolithic substrate which is free of any polyvinyl chloride, polyvinyl chloride acetate, or polyester.

3. The authorization card of claim 1 wherein the thin plastic body comprises cellulose acetate.

4. The authorization card of claim 1 wherein the thin plastic body comprises acetate propionate.

5. The authorization card of claim 1 wherein the thin plastic body comprises cellulose acetate butyrate.

6. The authorization card of claim 1, wherein the plastic card has a perimeter defining an interface between the plastic body and an environment exterior of the card, wherein the fragrance is diffusable through the interface into the environment from either of the first or second broad surface.

7. The authorization card of claim 1 wherein the machine readable code is included within a magnetic stripe disposed on one of the first and second broad surfaces.

8. The authorization card of claim 1 further comprising a laminate disposed on a portion of at least one of the first and second broad surfaces such that at least a portion of the first and second broad surfaces are exposed.

9. The authorization card of claim 1 wherein sections of the first and second broad surface are exposed to the environment and have a matted finish.

10. The authorization card of claim 8 wherein the magnetic stripe is disposed on the laminate.

11. The authorization card of claim 1 wherein the plastic body has translucency.

12. The authorization card of claim 1 wherein the machine readable code is a bar code disposed on at least one of the first broad surface and the second broad surface.

13. The authorization card of claim 1, further comprising printed indicia on a portion of at least one of the first and second broad surfaces, wherein the printed indicia comprises dithered ink dots supported on the plastic body.

14. An authorization card, consisting essentially of:
a monolithic plastic core having a first broad surface, a second broad surface opposite the first broad surface and an edge therebetween;
a fragrance embedded in the core;
printed indicia comprising dithered ink dots supported on the card; and
a machine readable code supported on the core.

15. The authorization card of claim 14, wherein the core of the card comprises a monolithic substrate which is free of any polyvinyl chloride, polyvinyl chloride acetate or polyester.

16. The authorization card of claim 14, wherein the machine readable code comprises a magnetic stripe.

17. The authorization card of claim 14, wherein the core comprises a cellulosic.

18. The authorization card of claim 14, wherein the cellulosic is selected from cellulose acetate, cellulose acetate butyrate or cellulose acetate propionate.

19. The authorization card of claim 17, wherein the cellulosic is cellulose acetate propionate.

20. The authorization card of claim 17, wherein the cellulosic is cellulose acetate.
